(19) United States
(12) Patent Application Publication
(10) Pub. No.: US 2004/0173387 A1
(43) Pub. Date: Sep. 9, 2004

(54) Gripper devices

(76) Inventors: Frank J. Criscione II, Gladstone, MO (US); Robert G. Jones, Dartmouth (CA); Antoine J.H. Winkelmolen, Shawnee, KS (US)

Correspondence Address: SPENCER, FANE, BRITT & BROWNE, 1000 WALNUT STREET, SUITE 1400, KANSAS CITY, MO, 64106-2140, US

(21) Appl. No.: 10/674,714

(22) Filed: Sep. 29, 2003

Related U.S. Application Data
(63) Continuation-in-part of application No. 10/262,223, filed on Oct. 1, 2002.

(51) Int. Cl. G01G 19/00

(52) U.S. Cl. 177/145

(57) ABSTRACT

Apparatuses and methods of picking up items from a first location and selectively releasing those items at one of multiple desired second locations are provided in which an item is either pierced, clamped, or stuck to a gripper without using vacuum pressure to maintain the grasp between the item and the pickup device. In several embodiments the items are grasped by piercing probes such as an expandable needle, a barbed needle or a screw. In other embodiments the items are clamped by tweezers or a gear and fingers combination. In a final embodiment, an item is grasped by being frozen to a temperature controllable surface.

This application is a continuation-in-part (CIP) of co-pending U.S. patent application Ser. No. 10/262,223 to Winkelmolen, filed Oct. 1, 2002.

### FIELD OF THE INVENTION

The present invention relates to methods and apparatuses for picking up and transferring those items from a first location to a second location. More particularly, the present invention relates to methods and apparatuses for picking up semi-rigid or non-rigid items having a slippery surface and irregular shape (such as chicken parts or other food items) from a first location and selectively releasing the picked up items at one of multiple predetermined release locations.

### BACKGROUND OF THE INVENTION

In food processing facilities, it is typically necessary to select a single article/object or food item from a bulk load of such food items and to grade, or weigh or measure some attribute of the food item. This is done for purposes of pricing the food item or for meeting particular specifications related to the food item. Once the attribute for the food item has been determined, it is then often necessary to place the food item into a segregated location along with a group of other food items having the same or similar attribute(s). Historically, apparatuses and methods for determining attributes of food items have required that a single food item be removed from the bulk load at a first location, placed on a conveyor at a second location, and then moved via the conveyor to a device for measuring the attribute. Such apparatuses and methods have generally included an array of vacuum devices, each for picking up a single food item and transporting the food item from the first location to the second location.

Although vacuum pick-up devices, such as those disclosed in U.S. Pat. No. 5,725,082 which is incorporated herein by reference, are extremely reliable for firmly grasping and transporting item bodies of semi-rigid or non-rigid structure and having a slippery surface and irregular shape, such as chicken parts, arrays of these devices are designed primarily for releasing items at a single, fixed location. This is because vacuum pick-up devices require application of significant and continuous suction on the item being transported, and thus a complex valve arrangement or some other means of terminating vacuum pressure at the desired release location is necessary when arrays of multiple pick-up devices are involved. When multiple possible release locations are available, the application and termination of vacuum pressure becomes even more complicated, and can add substantially to the overall size and cost of the machinery used in a food processing facility.

As traditional apparatuses and methods for determining attributes do in fact transport and release each food item to a single fixed location on a conveyor, the use of vacuum pick-up devices has worked very well. Nevertheless, due to the recent invention of apparatuses and methods for product attribute measurement, as disclosed in currently-pending U.S. patent application Ser. No. 10/262,223 to Winkelmolen, incorporated herein by reference, which provide for item attribute measurement while the item is being transported from the bulk load and prior to release at a second location, it has become desirable to develop apparatuses and methods for picking up a food item at a first location and selectively releasing the food item at one of multiple possible second locations. Given the difficulties in permitting selective location release with the vacuum pick-up devices of the prior art, it is desirable to develop apparatuses and methods for picking up a food item at a first location and selectively releasing the food item at one of multiple possible second locations that do not utilize vacuum pressure to grasp the item.

### SUMMARY OF THE INVENTION

An object of the present invention is to provide apparatuses and methods for picking up a food item, or other object, at a first location and selectively releasing the food item at one of multiple possible second locations. A further object of the present invention is to provide apparatuses and methods for picking up a food item, or other object, at a first location and selectively releasing the food item at one of multiple possible second locations that are simple yet reliable in design, construction and operation. Yet another object of the present invention is to provide an array of apparatuses each for picking up a single food item, or other object, at a first location from a group of bulk items and selectively releasing the food item at one of multiple possible second locations.

In order to overcome the difficulties with the prior art and achieve the above described objects, the instant invention provides several alternative embodiments of methods and apparatuses for picking up a food item at a first location and selectively releasing the food item at one of multiple possible second locations. The methods and apparatuses of the instant invention utilize unique gripper devices and/or unique methods of grasping/gripping objects that are vastly more versatile than the vacuum-controlled object pickup devices and object pickup methods of the prior art. The gripper devices and grasping methods of the instant invention allow for an array of pickup devices to each be individually controlled to release an item at one of numerous possible locations or bins without the need for complex valve arrangements as are required to supply continuous suction with the vacuum pickup devices and methods of the prior art.

In several embodiments of the present invention, an item, such as a chicken part, is picked up by a piercing probe such as an expandable needle, a barbed ended spear, or a screw that protrudes from an object pickup device. In operation, the object pickup device is positioned over a conveyor or some other area holding items, i.e. chicken parts, in bulk. The object pickup device is moved into close proximity to the bulk chicken parts and the piercing probe, or gripper, is manipulated so that the gripper pierces the item and then continuously holds the item as the object pickup device is moved to a position where release of the item is desired. The gripper is then manipulated so that the piercing probe is withdrawn from the item and the item is released.

In one embodiment of the instant invention, the piercing probe gripper includes an expandable needle similar to a balloon-tipped catheter tube used in angioplasty procedures. In the preferred embodiment, the expandable needle includes a generally rigid body constructed of steel, hard plastic, or any other suitable structural material. The needle body includes a sharpened or pointed rigid endpoint for piercing the item that is to be picked up. In the preferred embodiment of the expandable needle, a small section of the needle body, located relatively close to the endpoint, is constructed of rubber, an elastomer, or any other suitable material having elastic properties or otherwise capable of creating the desired expansion. Once the needle pierces the item that is to be picked up, the expandable section is expanded to form a bulge in the otherwise smoothed surface of the needle body and preventing premature disengagement of the item from the needle. The object pickup device then moves toward a desired release location and the expandable section of the needle body will be manipulated to collapse/remove the bulge, allowing the item to slip off of the needle.

In another embodiment of the instant invention, the piercing probe gripper includes a barbed endpoint, similar to a spear or fish hook, located on the end of a generally rigid needle. In operation, the needle is manipulated to pierce the item that is to be picked up and the barbed endpoint will prevent the item from slipping off of the needle. The object pickup device then moves toward a desired release location and the needle is retracted into a cavity of the pickup device, causing the item to be biased against the outer surface of the pickup device and disengaging the barb from the item, thus allowing the item to slip off of the needle.

In yet another embodiment of the instant invention, the piercing probe gripper includes a generally sharp-pointed threaded screw. In operation the object pickup device is located in close proximity to the item that is to be picked up, such that the endpoint of the screw gripper is in contact with the item. The screw gripper is then rotated in a direction that causes the screw threads to pierce and continue into the item, affixing the item to the screw. The object pickup device then moves toward a desired release location and the screw is rotated in the reverse direction causing the screw threads to retract from the item and ultimately causing the item to release from the screw.

In several alternative embodiments of the instant invention, an item, such as a chicken part, is picked up by a gripper that does not necessarily pierce the surface of the item. In operation, the object pickup device is positioned over a conveyor or some other area holding items, i.e. chicken parts, in bulk. The object pickup device is moved into close proximity to the bulk chicken parts and the gripper is manipulated engage/grasp the outer surface of the item and then continuously hold the item as the object pickup device is moved to a position where release of the item is desired. The gripper is then manipulated so as to disengage the outer surface of the item and the item is released.

In one embodiment of the instant invention, the outer-surface engaging gripper includes tweezers. In operation, the object pickup device is positioned in close proximity to the item that is to be picked up. The tweezers are extended outward from a cavity of the object pickup device, causing the fingers of the tweezers to spring apart from each other. The tweezers are then manipulated to locate the item between the fingers of the tweezers and the tweezers are retracted into the cavity of the object pickup devices, causing the fingers to clamp together and grasp the item. The object pickup device then moves toward a desired release location and the tweezers are extended outward from the cavity of the object pickup device, causing the item to be released.

In another embodiment of the instant invention, the outer-surface engaging gripper includes a gear and finger. The gear and finger gripper operates in a similar fashion to the tweezers described above; however, combination of a gear and finger(s), allows for a wide variety of finger configurations, shapes and sizes that are not available with the generally straight finger design of tweezers. For example, a first finger can be fixed, while another finger is manipulated by the gear to open and close (or clamp) with the fixed finger. In another arrangement, a single finger can be utilized that opens and closes with a surface of the object pickup device. In operation, the object pickup device is positioned in close proximity to the item that is to be picked up. The gear is manipulated to place the finger(s) in an open position and the item is located in the opening. The gear is then manipulated to place the finger(s) in a closed position, causing the fingers to clamp together and grasp the item. The object pickup device then moves toward a desired release location and the gear is manipulated to open the fingers, causing the item to be released.

In yet another embodiment of the instant invention, the outer-surface engaging gripper includes a temperature controllable surface. This embodiment is particularly useful in grasping food items, such as chicken parts, that inherently include a minimum moisture content. In operation the object pickup device is located in close proximity to the item that is to be picked up, such that the temperature controllable surface is in contact with the item. The temperature controllable surface is then adjusted to a cold temperature, freezing the moisture in the item and causing the item to freeze to the surface. The object pickup device then moves toward a desired release location and the surface is adjusted to a warmer temperature, thawing the point of engagement and releasing the item.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a plan view of an attribute measurement and item separation process line that utilizes the apparatuses and methods for transferring objects of the present invention.

FIG. 2a is a front cross-sectional view of an expandable needle pickup device of the present invention in a disengaged position.

FIG. 2b is a front cross-sectional view of the expandable needle pickup device of FIG. 2a of the present invention in an engaged position.

FIG. 3a is a front cross-sectional view of a tweezers pickup device of the present invention in a disengaged position.

FIG. 3b is a front cross-sectional view of the tweezers pickup device of FIG. 3a of the present invention in an engaged position.

FIG. 3c is a front cross-sectional view of a gripper assembly of the tweezers pickup device of FIGS. 3a and 3b.

FIG. 4a is a front cross-sectional view of a barbed piercing probe pickup device of the present invention in an engaged position.

FIG. 4b is a front cross-sectional view of the barbed piercing probe pickup device of FIG. 4a of the present invention in a disengaged position.

FIG. 4c is a front cross-sectional view of a gripper assembly of the barbed piercing probe pickup device of FIGS. 4a and 4b.

FIG. 5 is a front cross-sectional view of a screw pickup device of the present invention.

FIG. 6a is a front cross-sectional view of a gear and finger pickup device of the present invention in a disengaged position.

FIG. 6b is a front cross-sectional view of the gear and finger pickup device of FIG. 6a of the present invention in an engaged position.

FIG. 7 is a front cross-sectional view of a temperature controllable surface pickup device of the present invention.

### DESCRIPTION OF THE PREFERRED EMBODIMENT

As required, detailed embodiments of the present inventions are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIG. 1, an attribute measurement and item separation process line 80 is shown in which items 13 are to be picked up from a bulk supply delivery station, 12, and transferred to one of multiple possible second locations depending upon the result of an attribute measurement (e.g., a particular weight, color, texture and/or hardness). In the embodiment shown in FIG. 1 and described below the measured attribute for an item is its weight. Item separation process line 80 includes delivery station 12, product transfer station 28, distribution conveyor 40, and recirculation conveyor 54, all connected to a support frame.

As shown in FIG. 1, a series of item release locations, including distribution conveyor 40, bins A′, B′, C′ and D′ for holding items, and recirculation conveyor 54, are distributed around the circumference of product transfer station 28. Bins A′, B′, C′ and D′ are intended for direct release of items from product transfer station 28. As there is a finite amount of space located directly around the circumference of product transfer station 28, it may be desirable to have additional bins located away from product transfer station 28, at a location where additional space is available. Thus, distribution conveyor 40 is provided as a release location to move items away from product transfer station 28. Additional bins A, B, C, D, E, F, G and H are located along distribution conveyor 40 for holding items deflected off distribution conveyor 40 by deflection arms 42. An array of pickup units 21 are attached to product transfer station 28 via pickup arms 24, which rotate about central shaft 26. Each pickup unit includes pickup head 22 designed to pickup an item from delivery station 12 and selectively release the item and at one of the item release locations.

The entire operation of processing line 80 is controlled by computer 38. Bulk items 13, such as chicken parts, will enter the processing line via a delivery conveyor (not shown) that will deposit items 13 on turntable 14 of delivery station 12. As shown in FIG. 1, turntable 14 rotates in a clockwise direction and intersects the clockwise (or counterclockwise) rotation of product transfer station 28. Pickup units 21 are located above turntable 14 to enable pickup of individual item 20 from bulk items 13 as pickup units 21 travel across turntable 14 at the point of intersection. Once a single item 20 has been picked up by pickup unit 21, the clockwise rotation of transfer station 28 causes pickup arm 24 to move across load cell 82 that is incorporated into cam 84 through which pickup arm 24 travels. Computer 38 registers the weight from load cell 82, which includes the weight of pickup unit 21 and the weight of the item, and subtracts from that weight the tare weight of the pickup unit that was measured by tare weight load cell 88 prior to pickup of the item to determine the weight of item 20. Computer 38 then utilizes preprogrammed standards to determine the appropriate release location for item 20 based upon its weight, and releases the item from pickup unit 21 as the item rotates across the desired release location. If item 20 is to be placed in any of bins A′, B′, C′ or D′, it will be released directly into those bins from pickup unit 21. If item 20 is to be placed in any of bins A-H however, it will be released at location P from pickup unit 21, and distribution conveyor 40 will transport the item past point Q to point R, where the appropriate deflection arm 42 will be activated to deflect the item into the desired bin. When full, bins A′-D′ and A-H can be removed for further processing of the items within those bins. If an item 20 is outside of specifications or requires reworking it can be dropped onto recirculation conveyor 54 for a second pass through processing line 80. Recirculation conveyor 54 can be used to simply recycle item 20 or a worker E′ can be stationed near recirculation conveyor 54 to rework or modify a item 20 which was determined to be outside of specifications.

Referring now to FIGS. 2 through 7, several embodiments of pickup heads 22 of the present invention will be discussed. FIGS. 2(a, b), 4(a, b) and 5(a, b) all show embodiments of pickup heads 22 that each includes a gripper that pierces an item as it grasps the item. Alternatively, FIGS. 3(a, b), 6(a, b) and 7 all show embodiments of pickup heads 22 that each includes a gripper that engages the outer surface of an item without necessarily requiring piercing of the item.

FIGS. 2a and 2b show one embodiment of a piercing gripper of the instant invention in which pickup head 22 includes expandable needle 34 within housing 32. Needle 34 is constructed similar to a balloon-tipped catheter tube that is commonly used in angioplasty procedures. Needle 34 includes a generally rigid body constructed of steel, hard plastic, or any other suitable structural material. The needle body includes sharpened or pointed rigid endpoint 35 for piercing the item that is to be picked up. Expandable section 36 of needle 34 is constructed of a material capable of expansion and contraction, such as rubber, an elastomer, or any other suitable material having elastic properties or otherwise capable of creating the desired expansion.

In operation of the pickup head 22 shown in FIGS. 2a and 2b, computer 38 controls endpoint 35 of needle 34 to pierce the item that is to be picked up, and then manipulates expandable section 36 to form a bulge in the otherwise generally smooth surface of needle 34, as shown in FIG. 2b. Because the bulge created by the expansion of section 36 is larger in diameter than the hole created in the item by the piercing needle, the bulge will prevent premature disengagement of the item from the needle. The item is then transported to the desired release location via product transfer station 28, as described above with respect to FIG. 1, and computer 38 contracts the bulge of expandable section 36, as shown in FIG. 2a, allowing the item to slip off of the needle.

It will be appreciated that expandable section 36 of needle 34, and the manner in which it pierces and releases the object to be picked up, can be accomplished in a wide variety of arrangements and designs without departing from the scope of the present invention. For example needle 34 and expandable section 36 can be formed as a single integral unit, or can alternatively be formed as two separate components that are attached together. When needle 34 and expandable section 36 are formed as two separate components, expandable section 36 can be located within needle 34 or on the outer surface of needle 34. If expandable section 36 is located within needle 34, needle 34 may include apertures or slits to permit expandable section 36 to expand from within needle 34 and protrude outside of needle 34 to form the bulge. Needle 34 can be permanently affixed to housing 32, such that the movement of pickup head 22 itself generates the force necessary to pierce the item. Alternatively, needle 34 can be equipped with a mechanism for extending and retracting needle from housing 32, as is discussed below with respect to alternative embodiments of the instant invention. In such an arrangement, it is necessary only to position pickup head 22 above an item and then extend needle 34 from housing 32 to pierce the item.

It will also be appreciated that the manner in which expandable section 36 is expanded and contracted can be accomplished by numerous means, all of which are within the scope of the instant invention, including but not limited to pneumatics, hydraulics, or mechanical expansion. In one embodiment, needle 34 is a hollow tube that is connected to a small air line. Computer 38 will activate the air supply to pressurize hollow needle 34 and cause section 36 to expand. Alternatively, section 36 can be expanded by actuation of a piston or some other mechanical member that protrudes in a direction generally orthogonal to the length of needle 34.

FIGS. 3a, 3b and 3c show an embodiment of the gripper of the instant invention in which pickup head 22 includes tweezers 334. Tweezers 334 include two finger members 335 extending from a single intersection point 336 such that finger members 335 are in an open arrangement when no pressure is applied. Tweezers 334 are constructed of a metal or any other material having suitable elastic properties such that fingers 335 are capable of being positioned in a closed arrangement through the application of pressure to the outer sides of fingers 335 and returning to an open arrangement when such pressure is removed. Intersection point 336 is connected to a piston member 337 via extension member 338. Piston member 337 is contained in cavity 330 of housing 32 with extension member 338 extending downward through housing opening 333 such that fingers 335 are capable of protrusion from housing 32 through opening 333. Spring 339 is located in cavity 330 between the bottom wall of cavity 330 and piston member 337, such that the compressive force of spring 339 will urge piston member 337 upward toward the top of cavity 330 when no downward force is applied to piston 337. As shown in FIG. 3b, the walls of opening 333 apply inward pressure to the outer sides of fingers 335 as piston 337 moves upward in cavity 330, causing fingers 335 to close.

In operation, computer 38 positions the object pickup device, including pickup head 22 of FIGS. 3a through 3c, in close proximity to the item that is to be picked up. As is shown in FIG. 3a, computer 38, through application of air pressure through airline 331 into cavity 330, forces piston 337 downward, compressing spring 339, and allowing fingers 335 to extend outward through opening 333 and into an open arrangement. The object pickup device is then manipulated by computer 38 to locate the item between fingers 335 of tweezers 334, and computer 38 releases the air pressure from cavity 330 causing piston 337 to be forced upward by spring 339 and causing fingers 335 to close together and grasp the item, shown in FIG. 3b. Computer 38 then moves the object pickup device toward a desired release location and air pressure is applied to cavity 330 to force piston 337 downward to compress spring 339 and result in release of the item as fingers 335 open.

It will be appreciated that the manner in which fingers 335 of tweezers 334 are opened and closed can be accomplished by a wide variety of embodiments, all of which are within the scope of the instant invention. For example, spring 339 could be place on the top of piston 337, urging piston 337 downward, and thus vacuum pressure could be utilized to urge piston 337 upward. Alternatively, spring 339 could be eliminated and the position of piston 337 could be controlled simply by the application of increased pressure to move the piston downward, and the removal of pressure creating a vacuum to pull the piston upward. Other embodiments could be contemplated that eliminate piston 337 entirely and utilize other mechanical, or electromechanical means of opening and closing tweezers 334.

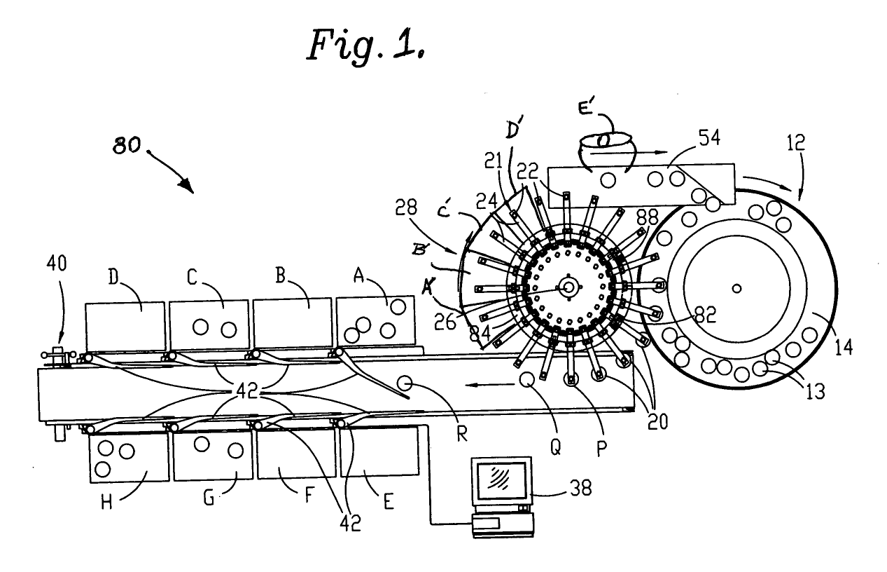

FIGS. 4a, 4b and 4c show an embodiment of the piercing probe gripper of the instant invention in which pickup head 22 includes needle 34 within housing 32, and in which sharpened endpoint 35 of needle 34 further includes barb 37. Barb 37 is constructed in similar fashion as a spear head or a fish hook. Needle 34 is connected to piston member 437. Piston member 437 is contained in cavity 430 of housing 32 with needle 34 extending downward through housing opening 433 such that endpoint 35 is capable of protrusion from housing 32 through opening 433. As shown in FIG. 4b, the walls of opening 433 closely surround barb 37 when needle 34 is retracted. This allows bottom surface 434 of housing 32 to bias against the outer surface of an item being retained by barb 37 as needle 34 is retracted into housing 32, causing the item to be released from barb 37.

In operation, computer 38 positions the object pickup device, including pickup head 22 of FIGS. 4a through 4c, in close proximity to the item that is to be picked up. Computer 38, through application of air pressure through an airline (not shown) into cavity 430, forces piston 437 downward causing endpoint 35 and barb 37 of needle 34 to extend outward through opening 433. The downward force of needle 34 will cause endpoint 35 and barb 37 to pierce the item that is to be picked up. Barb 37 will prevent the item from slipping off of needle 34. Computer 38 then moves the object pickup device toward a desired release location and air pressure is released, or a vacuum is applied to cavity 430 to move piston 437 upward causing needle 34 to retract into opening 433 of housing 32. As barb 37 of needle 34 is retracted into opening 433, the item being held will bias against bottom surface 434 of housing 32, causing barb 37 to be pulled out of the item.

It will be appreciated that the manner in which needle 34 is extended and retracted from housing 32 can be accomplished by a wide variety of embodiments, all of which are within the scope of the instant invention. For example, a spring mechanism similar to that discussed with respect to FIGS. 3a-3c above can be utilized to move the piston up and down. Alternatively, needle 34 can be rigidly attached to housing 32 as is discussed with respect to FIGS. 2a and 2b. Other embodiments could be contemplated that eliminate piston 437 entirely and utilize other mechanical, or electromechanical means of extending needle 34 into the item to be picked up.

FIG. 5 shows another embodiment of the instant invention in which piercing probe gripper 22 includes generally sharp-pointed threaded screw 534 protruding from housing 32. In operation, computer 38 positions the object pickup device in close proximity to the item that is to be picked up such that endpoint 535 of screw contacts the outer surface of the item. Computer 38 then causes screw 534 to rotate in a direction that will result in threads 537 piercing into the item and affixing the item to screw 534. Computer 38 then moves the object pickup device toward a desired release location and screw 534 is rotated in the reverse direction causing threads 537 to retract from the item and ultimately causing the item to release from screw 534.

The rotation of screw 534 can be accomplished by any means now known or hereinafter contemplated. For example, a shaft can extend through housing 32 to be connected to screw 534. The other end of the shaft can be connected to gears and a motor that is controlled by computer 38. FIG. 5 shows screw 534 as having a fixed length a protrusion from housing 32. Thus, in the embodiment of FIG. 5, as screw 534 rotates in either direction, its vertical position with respect to housing 32 will remain unchanged. Nevertheless, it will be appreciated that a similar pickup in which screw 534 extends and retracts from housing 32 as it is rotated is within the scope of the instant invention.

FIGS. 6a and 6b show an embodiment of the gripper of the instant invention very similar to that shown in FIGS. 3a-3c, with the primary difference being the replacement of the tweezers with gear and finger gripper 634. The inclusion of the gear and finger gripper allows for a virtually unlimited variety of finger shapes and sizes, which are not as easily accomplished using a tweezer type claim or gripper. Gripper 634 includes two finger members 635 rotatably connected to housing via bearings 636. Fingers 635 each include gear teeth members 632, which mesh together with each other to provide a rotatable connection between the two fingers. One of fingers 635 is connected to piston member 637 via extension member 638. Piston member 637 is contained in cavity 630 of housing 32 with extension member 638 extending downward through housing opening 633 such that extension member 638 protrudes from housing 32 through opening 633 to connect to fingers 635. Spring 639 is located in cavity 630 between the bottom wall of cavity 630 and piston member 637, such that the compressive force of spring 639 will urge piston member 637 upward toward the top of cavity 630 when no downward force is applied to piston 637.

In operation, computer 38 positions the object pickup device, including pickup head 22 of FIGS. 6a and 6b, in close proximity to the item that is to be picked up. As is shown in FIG. 6a, computer 38, through application of air pressure through airline 631 into cavity 630, forces piston 637 downward, compressing spring 639, and causing extension 638 to extend outward through opening 633. The outward/downward motion of extension 638 will cause gear teeth 632 to rotate such that fingers 635 rotate via bearings 636 into an open arrangement. The object pickup device is then manipulated by computer 38 to locate the item between fingers 635, and computer 38 releases the air pressure from cavity 630 causing piston 637 to be forced upward by spring 639 and causing fingers 635 to close together and grasp the item, shown in FIG. 3b. Computer 38 then moves the object pickup device toward a desired release location and air pressure is applied to cavity 630 to force piston 637 downward to compress spring 639 and result in release of the item as fingers 635 open apart from one another.

It will be appreciated that the manner in which fingers 635 are opened and closed can be accomplished by a wide variety of embodiments, all of which are within the scope of the instant invention and which have been discussed above with respect to alternative embodiments of the instant invention.

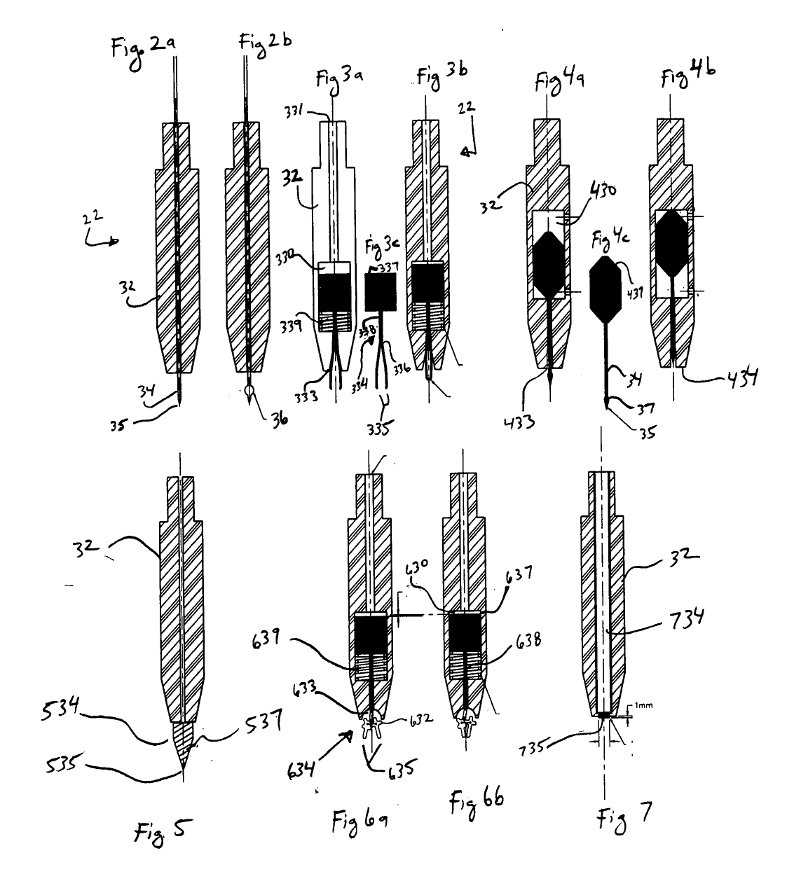

FIG. 7 shows an embodiment of the instant invention in which the outer-surface of the gripper includes temperature controllable surface 735 protruding from housing 32 of pickup head 22. This embodiment is particularly useful in grasping food items, such as chicken parts, that inherently include a minimum moisture content. As shown in FIG. 7, the temperature controllable surface is the bottom surface of stainless steel capped thin wall tube 734 which extends through housing 32. In operation the object pickup device is located via computer 38 into close proximity with the item that is to be picked up, such that temperature controllable surface 735 is in contact with the item. Computer 38 then adjust the surface 735 to a cold temperature by charging tube 734 with cold carbon dioxide, freezing the moisture in the item and causing the item to freeze to surface 735. The object pickup device then moves toward a desired release location and the surface is adjusted to a warmer temperature by discharging the carbon dioxide from the tube, thawing the point of engagement and releasing the item.

It will be appreciated that the means of providing variable temperature to surface alternative means of varying the temperature of surface 735 can be utilized without departing from the scope of this instant invention.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive apparatus and methods are constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention what is claimed as new and desired to be secured by Letters Patent is as follows:

1. An apparatus for transferring objects from a first location to a second location comprising:
a frame;
first means mounted on the frame for holding a plurality of objects;
second means for moving objects away from the first means;
third means for picking up objects from the first means and depositing the objects at the second means, said third means including a movable member, and a support mounted on the frame;
means supporting the member on the frame for movement relative to the first and second means;
drive means for moving the member;
an object pickup device mounted on the member, said object pickup device being operable to pickup an object in the first means, transport the object to a location above the second means and release the object thereby allowing the object to be placed at the second means;
said object pickup device further comprising a gripper protruding from said object pickup device for engagement with objects.

2. An apparatus for transferring objects from a first location to a second location comprising:
first means for holding a plurality of objects;
second means for holding objects;
third means for picking up objects from the first means and depositing the objects at the second means,
an object pickup device mounted on the third means, said object pickup device being operable to pickup an object in the first means, transport the object to a location above the second means and release the object thereby allowing the object to be placed at the second means;
said object pickup device further comprising a gripper protruding from said object pickup device for engagement with objects.

3. The apparatus as claimed in claim 2 wherein said gripper comprises a piercing probe.

4. The apparatus as claimed in claim 3 wherein said piercing probe comprises an expandable needle.

5. The apparatus as claimed in claim 3 wherein said piercing probe comprises a barbed endpoint.

6. The apparatus as claimed in claim 2 wherein said gripper comprises a tweezers.

7. The apparatus as claimed in claim 3 wherein said piercing probe comprises a screw.

8. The apparatus as claimed in claim 2 wherein said gripper comprises a gear and finger.

9. The apparatus as claimed in claim 2 wherein said gripper comprises a temperature controllable surface.

10. An apparatus for transferring objects from a first location to a second location comprising:
a frame;
first means mounted on the frame for holding a plurality of objects;
second means for moving objects away from the first means;
third means for picking up objects from the first means and depositing the objects at the second means, said third means including a movable member, and a support mounted on the frame;
means supporting the member on the frame for movement relative to the first and second means;
drive means for moving the member;
an object pickup device mounted on the member, said object pickup device being operable to pickup an object in the first means, transport the object to a location above the second means and release the object thereby allowing the object to be placed at the second means;
said object pickup device further comprising a temperature controllable gripper for engagement with objects.

11. An apparatus for transferring objects from a first location to a second location comprising:
first means for holding a plurality of objects;
second means for holding objects;
third means for picking up objects from the first means and depositing the objects at the second means;
an object pickup device mounted on the third means, said object pickup device being operable to pickup an object in the first means, transport the object to a location above the second means and release the object thereby allowing the object to be placed at the second means;
said object pickup device further comprising a temperature controllable gripper for engagement with objects.

12. A method of transferring objects from a first location to a second location comprising:
locating an object pick-up means above the first location containing at least one object,
moving the object pick-up means toward and in close proximity to the object in the first location and engaging a protruding gripper of said pick-up means with the object to retain the object on said pick-up means,
transporting the pick-up means and object retained thereon during engagement from said first location to a position above the second location,
releasing the object from the pick-up means by disengaging said gripper from the object whereby the object moves away from the pick-up means to the second location.

13. The method as claimed in claim 12 wherein said step of engaging a gripper of said pick-up means with the object further comprises the step of piercing the object with said gripper.

14. The method as claimed in claim 13 wherein said step of engaging a gripper of said pick-up means with the object further comprises the steps of expanding a portion of said gripper to prevent premature disengagement of the object from said gripper.

15. The method as claimed in claim 14 wherein said step of disengaging said gripper from the object further comprises the step of collapsing said expanded portion of said gripper.

16. The method as claimed in claim 13 wherein said gripper includes a barbed endpoint.

17. The method as claimed in claim 13 wherein said piercing step further comprises the step of extending said gripper from said pick-up means.

18. The method as claimed in claim 13 wherein said releasing step further comprises the step of retracting said gripper.

19. The method as claimed in claim 18 wherein an endpoint of said gripper is retracted into a cavity of said pick-up means, causing the object to disengage from the gripper as said gripper is retracted and the object is biased against an outer surface of the pick-up means.

20. The method as claimed in claim 13 wherein said piercing step further comprises the step of screwing said gripper into the object.

21. The method as claimed in claim 12 wherein said step of engaging a gripper of said pick-up means with the object further comprises the step of clamping the object with said gripper.

22. The method as claimed in claim 21 wherein said step of clamping the object is performed by a tweezers.

23. The method as claimed in claim 21 wherein said step of clamping the object is performed by a gear and finger.

24. The method as claimed in claim 12 wherein said step of engaging a gripper of said pick-up means with the object further comprises the steps of:
adjusting a temperature controllable surface of said gripper to a cold temperature; and
contacting the object with said temperature controllable surface.

25. The method as claimed in claim 24 wherein said step of disengaging said gripper from the object further comprises the step of adjusting said temperature controllable surface of said gripper to a warm temperature.

26. A method of transferring objects from a first location to a second location comprising:
locating an object pick-up means above the first location containing at least one object,
moving the object pick-up means toward and in close proximity to the object in the first location and contacting the object with a temperature controllable surface of said pick-up means that has been adjusted to a cold temperature to retain the object on said pick-up means,
transporting the pick-up means and object retained thereon from said first location to a position above the second location,
releasing the object from the pick-up means by adjusting said temperature controllable surface to a warm temperature whereby the object moves away from the pick-up means to the second location.

27. An object pickup device for use in an apparatus for transferring objects from a first location to a second location, the apparatus including an array of said object pickup devices, said object pickup device comprising:
a gripper protruding from said object pickup device for engagement with objects.

28. An object pickup device for use in an apparatus for transferring objects from a first location to a second location, the apparatus including an array of said object pickup devices, said object pickup device comprising:
a temperature controllable gripper for engagement with objects.
